(19) United States
(12) Patent Application Publication
(10) Pub. No.: US 2013/0320003 A1
(43) Pub. Date: Dec. 5, 2013

(54) MICROWAVE OVEN AND METHOD FOR CONTROLLING INPUT THEREOF

(71) Applicant: SAMSUNG ELECTRONICS CO., LTD., Suwon-si (KR)

(72) Inventor: Kum Chul HWANG, Bucheon-Si (KR)

(73) Assignee: SAMSUNG ELECTRONICS CO., LTD., Suwon-si (KR)

(21) Appl. No.: 13/888,673

(22) Filed: May 7, 2013

(30) Foreign Application Priority Data
Jun. 5, 2012 (KR) 10-2012-0060651

(51) Int. Cl. H05B 6/64

(52) U.S. Cl. CPC H05B 6/6435
USPC 219/720

(57) ABSTRACT

A microwave oven that may conveniently input automatic or manual cooking using only one dial and a method for controlling input of the microwave oven are provided. An automatic or manual cooking mode can be selected using one dial and a detailed cooking function of the selected cooking mode can be set, so that the number of devices for input can be reduced and manipulation performance of both a user who is not accustomed to the microwave oven and a user who is accustomed to the microwave oven can be improved.

### CROSS-REFERENCE TO RELATED APPLICATIONS

This application claims the priority benefit of Korean Patent Application No. 10-2012-0060651, filed on Jun. 5, 2012 in the Korean Intellectual Property Office, the disclosure of which is incorporated herein by reference.

### BACKGROUND

1. Field

Embodiments relate to a microwave oven that may conveniently input automatic or manual cooking using one dial.

2. Description of the Related Art

In general, a cooking device, for example, a microwave oven, is a device in which microwaves of about 2,450 MHz generated by applying high-voltage electricity to a magnetron that is a high-frequency oscillation tube vibrate water molecules contained in a cooking object and the cooking object is rapidly heated by frictional heat generated by this vibration.

When the cooking object is cooked using such a cooking device, a user selects a cooking mode between a manual cooking mode in which a cooking time needs to be directly input and an automatic cooking mode in which a state of the cooking object is detected during a cooking operation using a cooking menu in which a cooking time is preset, or an appropriate cooking time is automatically calculated using the result of detection by one or more sensors, such as a humidity sensor, a gas sensor, or a temperature sensor. Subsequently, a setting value of the selected cooking mode (specifically, a detailed cooking function of each cooking mode) should be set.

That is, in order to select automatic or manual cooking, a mode key is pressed or a mode dial is manipulated so as to select an automatic or manual cooking mode, and then a separately-provided setting dial is manipulated to set a detailed cooking function (in case of the automatic cooking mode, a cooking item and in case of the manual cooking mode, a cooking time) of the selected cooking mode.

In this way, the cooking device according to the related art should provide a mode dial (or mode key) for selecting a cooking mode and a separate setting dial for setting a detailed cooking function of each cooking mode so as to input automatic or manual cooking. Thus, two or more devices for input are required.

Also, a user who is not accustomed to the cooking device has a difficulty of manipulation regarding which dial is manipulated to select desired cooking, and even in case of a user who is accustomed to the cooking device, there are inconveniences of manipulation regarding that a dial need to be moved whenever the user selects desired cooking.

### SUMMARY

In an aspect of one or more embodiments, there is provided a microwave oven that may set an automatic or manual cooking mode and a detailed cooking function of each cooking mode using only one dial and a method for controlling input of the microwave oven.

In an aspect of one or more embodiments, there is provided a microwave oven including: one dial that is rotated in one direction to select a cooking mode from a plurality of cooking modes and is rotated in both directions to set a detailed cooking function of the selected cooking mode; and a display unit that displays a cooking mode selected according to rotation manipulation of the dial and a detailed cooking function of each cooking mode.

The cooking mode may include an automatic cooking mode and a manual cooking mode.

The one direction may include a first manipulation direction in which the dial is rotated to the left and a second manipulation direction in which the dial is rotated to the right.

The dial may select an automatic cooking mode according to rotation manipulation in the first manipulation direction and may set one cooking item among a plurality of cooking items according to rotation manipulation to in both right and left directions in a state in which the automatic cooking mode is selected.

When the dial is manipulated to be rotated in the first manipulation direction, the display unit may display an initial screen of the automatic cooking mode and then may display one among the plurality of cooking items that vary according to rotation manipulation of the dial in both right and left directions.

The dial may select a manual cooking mode according to rotation manipulation in the second manipulation direction and may set a cooking time according to rotation manipulation in both right and left directions in a state in which the manual cooking mode is selected.

When the dial is manipulated to be rotated in the second manipulation direction, the display unit may display an initial screen of the manual cooking mode and then may display the cooking time that varies according to rotation manipulation of the dial in both left and right directions.

The microwave oven may further include a controller that controls a cooking operation so as to perform a detailed cooking function of a cooking mode selected according to rotation manipulation of the dial.

In an aspect of one or more embodiments, there is provided a method for controlling input of a microwave oven that inputs automatic cooking or manual cooking using one dial, the method including: selecting a predetermined cooking mode by rotating the dial in one direction; and setting a detailed cooking function of the selected cooking mode by rotating the dial in both directions.

The method may further include displaying a cooking mode selected according to rotation manipulation of the dial and a detailed cooking function of each cooking mode using a display unit.

In an aspect of one or more embodiments, there is provided a microwave oven including one dial that is rotated in one of a first direction and a second direction to select a cooking mode from a first cooking mode and a second cooking mode, and that is rotated in both left and right directions to set a cooking function of the selected cooking mode; and a display unit that displays the cooking mode selected according to rotation manipulation of the dial and a cooking function of each cooking mode, wherein the first direction is a first manipulation direction in which the dial is rotated to the left and a second direction is a second manipulation direction in which the one dial is rotated to the right, and wherein the cooking function of cooking mode selected by rotating the one dial in the first direction is different from the cooking function of cooking mode selected by rotating the one dial in the second direction.

### BRIEF DESCRIPTION OF THE DRAWINGS

These and/or other aspects of embodiments will become apparent and more readily appreciated from the following detailed description, taken in conjunction with the accompanying drawings of which:

FIG. 1 is an exploded perspective view of a microwave oven according to an embodiment;

FIG. 2 is a view of a control panel of the microwave oven illustrated in FIG. 1;

FIG. 3 is a view of control configuration of the microwave oven of FIG. 1;

FIG. 4 is a flowchart illustrating an operation of a dial input control algorithm in the microwave oven of FIG. 1;

FIG. 5 is a view of automatic cooking input of the microwave oven of FIG. 1; and

FIG. 6 is a view of manual cooking input of the microwave oven of FIG. 1.

### DETAILED DESCRIPTION

Reference will now be made in detail to embodiments, examples of which are illustrated in the accompanying drawings, wherein like reference numerals refer to like elements throughout.

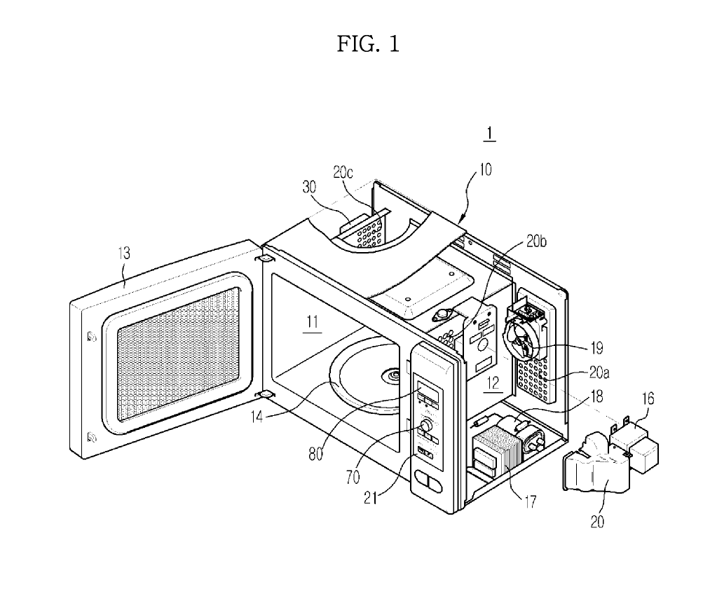

FIG. 1 is an exploded perspective view of a microwave oven according to an embodiment.

In FIG. 1, a microwave oven 1, according to an embodiment, is partitioned off into a box-shaped main body 10 that includes the exterior, a cooking chamber 11 that is installed in the main body 10 so as to cook a cooking object, and a machine chamber 12 in which various electric components are embedded.

A front side of the cooking chamber 11 is opened so that the cooking object may be accommodated in the cooking chamber 11, a door 13 is installed at the open front side of the cooking chamber 11 so as to open/close the cooking chamber 11, and a turntable 14 on which the cooking object is mounted is rotatably installed in the cooking chamber 11.

Also, various electric components, such as a general magnetron 16 that supplies a high frequency into the cooking chamber 11, a high-voltage transformer 17 and a high-voltage capacitor 18 that supply a high voltage to the magnetron 16, a cooling fan 19 that cools various electric components including the magnetron 16 installed in the machine chamber 12, and an air guide duct 20 that guides air discharged from the machine chamber 12, are installed in the machine chamber 12.

When the cooling fan 19 operates, external air (atmosphere) flows into the machine chamber 12 via absorption holes 20a to cool various electric components in the machine chamber 12. Subsequently, external air is supplied to the cooking chamber 11 via inlets 20b by using a guide of the air guide duct 20. Then, the external air is discharged to the outside via exhaust holes 20c together with water vapor generated in the cooking object.

A humidity sensor 30 that senses humidity of air inside the cooking chamber 11 is installed at one side of the exhaust holes 20c and detects a cooking condition (a cooking state of the cooking object) of the microwave oven 1. The humidity sensor 30 is installed to contact air discharged from the cooking chamber 11 via the exhaust holes 20c and detects moisture contained in water vapor generated in the cooking object when a cooking operation of the microwave oven 1 is performed.

The humidity sensor 30 is installed to detect a cooking condition when automatic cooking of the microwave oven 1 is performed. However, embodiments are not limited thereto, and a gas sensor or temperature sensor may also be installed so as to detect the cooking condition of the microwave oven 1.

A control panel 21 is installed at a front side of the machine chamber 12. The control panel 21 selects a cooking mode that a user wants and a detailed cooking function of each cooking mode and displays the selected cooking function and an operating state.

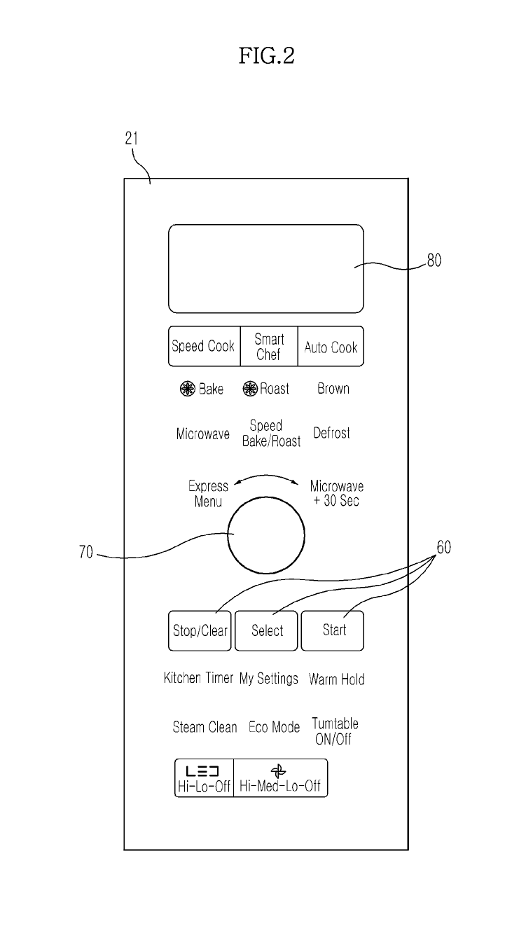

FIG. 2 illustrates the control panel of the microwave oven 1 of FIG. 1.

In FIG. 2, a plurality of buttons 60 to which a user's manipulation instruction is input so as to control the operation of the microwave oven 1, one dial 70 for selecting an automatic or manual cooking mode and for setting a detailed cooking function of the selected cooking mode, and a display unit 80 that displays the operating state of the microwave oven 1 and a user's manipulation state, are disposed on a control panel 21.

The dial 70 is positioned in the center of the control panel 21 and may be manipulated to be rotated to the right (clockwise) and to the left (counterclockwise).

The dial 70 has a first manipulation direction in which the dial 70 is rotated to the left and a second manipulation direction in which the dial 70 is rotated to the right. The dial 70 is manipulated to be rotated in the first manipulation direction or the second manipulation direction in a standby mode and sets an automatic or manual cooking condition.

This will now be described in more detail.

First, when the dial 70 is manipulated to be rotated by one click in the first manipulation direction in a standby mode state, an automatic cooking mode Express Menu is selected. Also, when the dial 70 is manipulated to be rotated by one click in the second manipulation direction in the standby mode state, a manual cooking mode Microwave +30 Sec is selected. In this case, the automatic or manual cooking mode is selected according to one-click rotation manipulation in the first manipulation direction or the second manipulation direction regardless of the position of the dial 70. Embodiments are not limited to a manual cooking mode Microwave +30 Sec. For example, a manual cooking mode may be Microwave +60 Sec or some other time period.

A direction in which the automatic cooking mode or the manual cooking mode is selected may be reversely configured according to rotation manipulation of the dial 70 in the first manipulation direction or the second manipulation direction. That is, when the dial 70 is manipulated to be rotated by one click in the first manipulation direction in the standby mode state, the manual cooking mode Microwave +30 Sec may be selected, and when the dial 70 is manipulated to be rotated by one click in the second manipulation direction in the standby mode state, the automatic cooking mode Express Menu may be selected.

In this way, the automatic or manual cooking mode that is selected as the dial 70 is manipulated to be rotated to the right or to the left, may be displayed on the display unit 80, and the user may check the selected cooking mode through the display unit 80.

After selecting the automatic or manual cooking mode by manipulating the dial 70 to be rotated in the first manipulation direction or the second manipulation direction, the user manipulates to freely rotate the dial 70 to the right and to the left, i.e., in both directions so as to set a detailed cooking function of the automatic or manual cooking mode.

This will now be described in more detail by way of an example.

When the dial 70 is manipulated to be rotated by one click in the first manipulation direction in the standby mode state, the automatic cooking mode Express Menu is selected. When the dial 70 is manipulated to be freely rotated in both directions in a state in which the automatic cooking mode is selected, a plurality of cooking items (for example, approximately 9 cooking menus) that are input in the automatic cooking mode may be set so that a cooking item may vary. In this case, the varying cooking item is displayed on the display unit 80, and the user may set a desired cooking item while checking the cooking item displayed on the display unit 80.

When the dial 70 is manipulated to be rotated by one click in the second manipulation direction in the standby mode state, the manual cooking mode Microwave +30 Sec is selected. When the dial 70 is manipulated to be freely rotated in both directions in a state in which the manual cooking mode is selected, a cooking time varies. In this case, the varying cooking time is displayed on the display unit 80, and the user sets a desired cooking time while checking the cooking time displayed on the display unit 80.

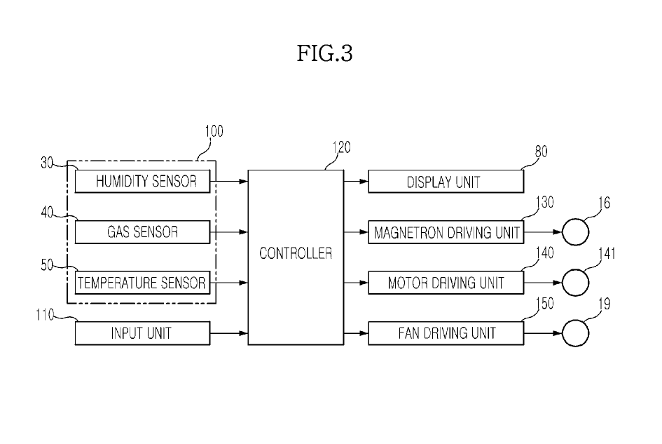

FIG. 3 is a view of control configuration of the microwave oven 1 of FIG. 1.

In FIG. 3, the microwave oven 1 includes the display unit 80, a sensor unit 100, an input unit 110, a controller 120, a magnetron driving unit 130, a motor driving unit 140, and a fan driving unit 150.

The display unit 80 is disposed on the control panel 21 and displays the operating state of the microwave oven 1 and the user's manipulation state according to a display control signal of the controller 120.

The sensor unit 100 detects a varying cooking condition, i.e., the state of the cooking object of the cooking chamber 11 when automatic cooking of the microwave oven 1 is performed. The sensor unit 100 refers to at least one among the humidity sensor 30 that detects the humidity of air inside the cooking chamber 11, a gas sensor 40 that detects the amount of gas inside the cooking chamber 11, and a temperature sensor 50 that detects the temperature inside the cooking chamber 11. The sensors 30, 40, and 50 are installed at one side of the exhaust holes 20c so as to contact air discharged from the cooking chamber 11.

The input unit 110 includes the plurality of buttons 60 and one dial 70 that are disposed on the control panel 21 so that the user may input desired cooking information (a cooking time, a cooking menu, automatic cooking using a sensor, start/stop cooking, and the like) to the controller 120.

The controller 120 may be a microcomputer that controls components of the microwave oven 1 according to manipulation information input from the input unit 110. The controller 120 controls an output of microwaves by determining the state of the cooking object based on a sensor output value input from the sensor unit 100.

The magnetron driving unit 130 includes a relay that controls driving of the magnetron 16 so as to generate microwaves according to a control signal of the controller 120.

The motor driving unit 140 drives a motor 141 so as to rotate the turntable 14 according to the control signal of the controller 120.

The fan driving unit 150 operates the cooling fan 19 that cools the machine chamber 12 according to the control signal of the controller 120 to ventilate the inside of the cooking chamber 11. The fan driving unit 150 cools the sensors 30, 40, and 50 using a ventilation air current so that the sensors 30, 40, and 50 may have stable operating characteristics.

Hereinafter, the microwave oven 1 illustrated in FIG. 1, operations of a method for controlling input of the microwave oven 1, and effects thereof will be described.

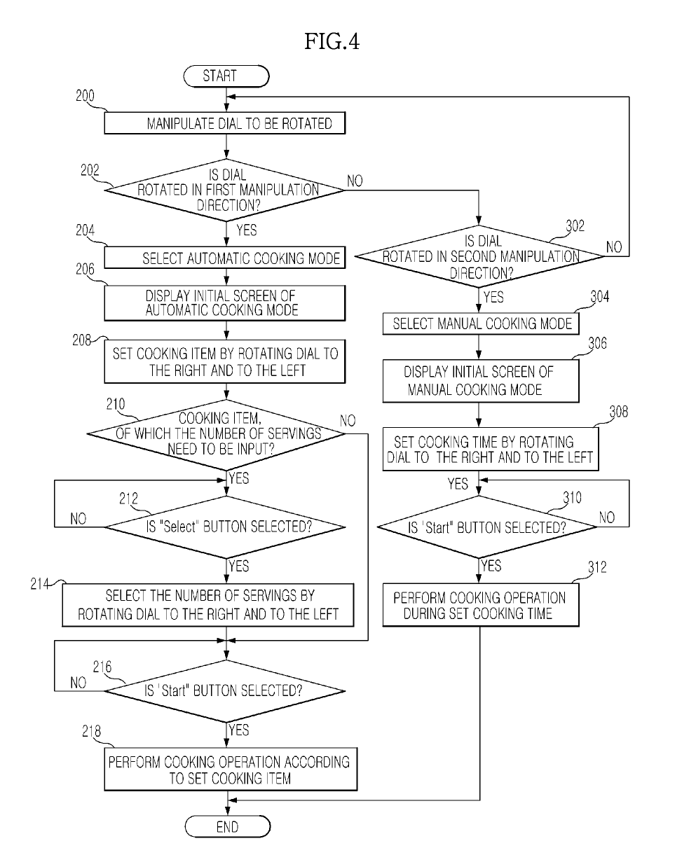

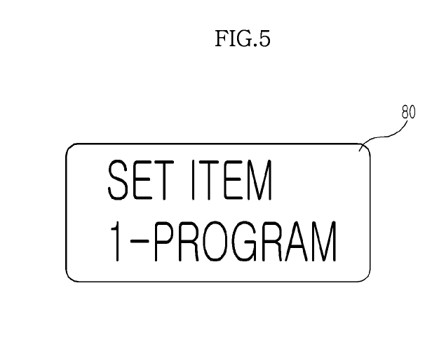

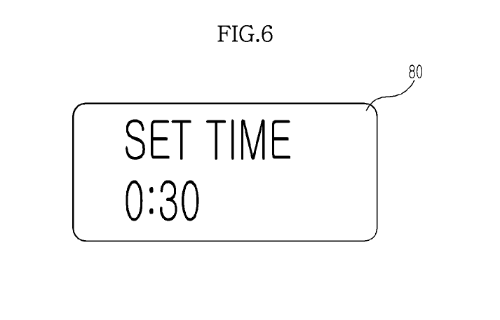

FIG. 4 is a flowchart illustrating an operation of a dial input control algorithm in the microwave oven 1 of FIG. 1, FIG. 5 is a view of automatic cooking input of the microwave oven 1 of FIG. 1, and FIG. 6 is a view of manual cooking input of the microwave oven 1 of FIG. 1.

In FIG. 4, the user puts the cooking object on the turntable 14 inside the cooking chamber 11 and manipulates the dial 70 disposed on the control panel 21 to be rotated, thereby inputting automatic or manual cooking (200).

A method of inputting automatic or manual cooking by manipulating the dial 70 to be rotated is as follows.

First, the user manipulates the dial 70 to be rotated by one click in the first manipulation direction (specifically, to the left) in the standby mode state so as to select an automatic cooking mode.

When the user manipulates the dial 70 to be rotated by one click in the first manipulation direction, the controller 120 determines whether the dial 70 is rotated in the first manipulation direction (202).

As a result of determination in Operation 202, if it is determined that the dial 70 is rotated in the first manipulation direction, the controller 120 determines that the user has selected the automatic cooking mode (204). Then, the controller 120 displays an initial screen of the automatic cooking mode on the display unit 80 disposed on an upper part of the control panel 21, as illustrated in FIG. 5 (206).

Thus, the user may check that the automatic cooking mode has been selected, through the initial screen of the automatic cooking mode displayed on the display unit 80.

Subsequently, the user manipulates the dial 70 to be freely rotated to the right and to the left, i.e., in both directions in a state in which the automatic cooking mode has been selected, thereby setting a cooking item of the automatic cooking mode (208).

The cooking item of the automatic cooking mode is a detailed cooking function in which a cooking condition (a cooking time and output of microwaves) is automatically detected using a cooking menu in which a cooking time is preset, or the humidity sensor 30, the gas sensor 40, and the temperature sensor 50. A plurality of (such as 9) cooking items corresponding to the detailed cooking function of the automatic cooking mode are stored in the controller 120 in advance, and the user sets a desired cooking item among the plurality of cooking items stored.

The cooking item that varies as the user manipulates the dial 70 to be rotated to the right and to the left, is displayed on the display unit 80, and the user sets a desired cooking item while checking the cooking item displayed on the display unit 80.

If the cooking item of the automatic cooking mode is set, the controller 120 determines whether the set cooking item is a cooking item, of which the number of servings need to be input, (a cooking item in which the number of cooking objects or the amount of a cooking object is set, for example, a cooking item in which the number of cooking objects, such as one potato, two potatoes, and the like) (210).

As a result of determination in Operation 210, in case of a cooking item, of which the number of servings need to be input, when the user presses a “Select” button disposed on the control panel 21 (212), the cooking item that is set by the user is finally selected, and the selected cooking item and serving information (for example, information for setting the number of cooking objects) about the cooking item are displayed on the display unit 80.

Subsequently, when the user manipulates the dial 70 to be rotated to the right and to the left, i.e., in both directions so as to select the number of servings of the cooking item (214) and then presses a “Start” button (216), the controller 120 controls the components of the microwave oven 1 during a cooking time of the set cooking item, thereby performing a cooking operation (218).

As a result of determination in Operation 210, in case of a cooking item, of which input of the number of servings is not necessary, the method goes to Operation 216. When the user presses the “Start” button disposed on the control panel 21, the controller 120 controls the components of the microwave oven 1 during the cooking time of the set cooking item, thereby performing a cooking operation (218).

Next, a method of inputting manual cooking by manipulating the dial 70 to be rotated will be described.

First, the user manipulates the dial 70 to be rotated by one click in the second manipulation direction (specifically, to the right) in the standby mode state so as to select a manual cooking mode.

When the user manipulates the dial 70 to be rotated by one click in the second manipulation direction, the controller 120 needs to determine whether the dial 70 is rotated in the second manipulation direction.

As a result of determination in Operation 202 described above, if it is determined that the dial 70 is not rotated in the first manipulation direction, the controller 120 determines whether the dial 70 is rotated in the second manipulation direction (302).

As a result of determination in Operation 302, if it is determined that the dial 70 is rotated in the second manipulation direction, the controller 120 determines that the user has selected the manual cooking mode (304). Then, the controller 120 displays an initial screen of the manual cooking mode on the display unit 80, as illustrated in FIG. 6 (306).

Thus, the user may check that the manual cooking mode has been selected, through the initial screen of the manual cooking mode displayed on the display unit 80.

Subsequently, the user manipulates the dial 70 to be freely rotated to the right and to the left, i.e., in both directions in a state in which the manual cooking mode is selected, thereby setting a cooking time of the manual cooking mode (308).

The cooking time of the manual cooking mode is input by the user according to the condition of a cooking object, i.e., the type, the weight, or the size of the cooking object.

The cooking time that varies as the user manipulates the dial 70 to be rotated to the right and to the left, is displayed on the display unit 80, as illustrated in FIG. 6, and the user sets a desired cooking time while checking the cooking time displayed on the display unit 80.

In this way, when, after the cooking time of the manual cooking mode is set, the user presses the “Start” button disposed on the control panel 21 (310), the set cooking time is displayed on the display unit 80.

Thus, the controller 120 controls the components of the microwave oven 1 during the set cooking time, thereby performing a cooking operation (312).

In one or more embodiments, an automatic or manual cooking mode may be selected using one dial and a detailed cooking function of the selected cooking mode may be set, so that the number of devices for input can be reduced and manipulation performance of both a user who is not accustomed to the microwave oven and a user who is accustomed to the microwave oven can be improved.

Although a few embodiments have been shown and described, it would be appreciated by those skilled in the art that changes may be made in these embodiments without departing from the principles and spirit of the disclosure, the scope of which is defined in the claims and their equivalents.

What is claimed is:

1. A microwave oven comprising:
one dial that is rotated in one direction to select a cooking mode from a plurality of cooking modes and is rotated in both left and right directions to set a cooking function of the selected cooking mode; and
a display unit that displays the cooking mode selected according to rotation manipulation of the dial and a detailed cooking function of each cooking mode.

2. The microwave oven according to claim 1, wherein the cooking modes include an automatic cooking mode and a manual cooking mode.

3. The microwave oven according to claim 2, wherein the one direction comprises a first manipulation direction in which the dial is rotated to the left and a second manipulation direction in which the dial is rotated to the right.

4. The microwave oven according to claim 3, wherein the dial selects an automatic cooking mode according to rotation manipulation in the first manipulation direction and sets one cooking item among a plurality of cooking items according to rotation manipulation to in both right and left directions in a state in which the automatic cooking mode is selected.

5. The microwave oven according to claim 4, wherein, when the dial is manipulated to be rotated in the first manipulation direction, the display unit displays an initial screen of the automatic cooking mode and then displays one among the plurality of cooking items that vary according to rotation manipulation of the dial in both right and left directions.

6. The microwave oven according to claim 3, wherein the dial selects a manual cooking mode according to rotation manipulation in the second manipulation direction and sets a cooking time according to rotation manipulation in both right and left directions in a state in which the manual cooking mode is selected.

7. The microwave oven according to claim 6, wherein, when the dial is manipulated to be rotated in the second manipulation direction, the display unit displays an initial screen of the manual cooking mode and then displays the cooking time that varies according to rotation manipulation of the dial in both right and left directions.

8. The microwave oven according to claim 1, further comprising a controller that controls a cooking operation so as to perform a cooking function of a cooking mode selected according to rotation manipulation of the dial.

9. A method for controlling input of a microwave oven using one dial, the method comprising:
selecting a cooking mode from a plurality of cooking modes by rotating the dial in one direction; and
setting a cooking function of the selected cooking mode by rotating the dial in both directions.

10. The method according to claim 9, further comprising displaying a cooking mode selected according to rotation manipulation of the dial and a cooking function of each cooking mode using a display unit.

11. The method according to claim 9, wherein the cooking mode comprises an automatic cooking mode or a manual cooking mode.

12. A microwave oven comprising:
one dial that is rotated in one of a first direction and a second direction to select a cooking mode from a first cooking mode and a second cooking mode, and that is rotated in both left and right directions to set a cooking function of the selected cooking mode; and
a display unit that displays the cooking mode selected according to rotation manipulation of the dial and a cooking function of each cooking mode,
wherein the first direction is a first manipulation direction in which the dial is rotated to the left and a second direction is a second manipulation direction in which the one dial is rotated to the right, and
wherein the cooking function of cooking mode selected by rotating the one dial in the first direction is different from the cooking function of cooking mode selected by rotating the one dial in the second direction.
